(19) United States
(12) Patent Application Publication
(10) Pub. No.: US 2007/0141306 A1
(43) Pub. Date: Jun. 21, 2007

(54) Process for preparing a superhydrophobic coating

(76) Inventors: Toshihiro Kasai, Kanagawa (JP); Koji Kamiyama, Kanagawa (JP); Kiyoshi Tadokoro, Kanagawa (JP)

Correspondence Address: 3M INNOVATIVE PROPERTIES COMPANY, PO BOX 33427, ST. PAUL, MN, 55133-3427, US

(21) Appl. No.: 11/314,131

(22) Filed: Dec. 21, 2005

(51) Int. Cl. B05D 3/02; E01F 9/04

(52) U.S. Cl. 428/143; 427/393.4; 427/180; 427/487

(57) ABSTRACT

A process comprises (a) applying a coating consisting essentially of at least one hydrophobic material to at least a portion of at least one surface of a substrate to form a water repellent layer; (b) disposing a plurality of particles on the water repellent layer, the particles being selected from porous particles, particle aggregates, and mixtures thereof; (c) at least partially embedding the particles in the water repellent layer; (d) at least partially hardening the water repellent layer; and (e) removing the at least partially embedded particles to form a microstructured coating; wherein the microstructured coating comprises a plurality of cavities that taper from the exposed surface of the coating toward the substrate.

### FIELD

This invention relates to processes for imparting water repellency and/or self-cleaning properties to substrates (for example, glass, metal, and plastic), to coatings produced thereby, and to articles comprising such coatings.

### BACKGROUND

Self-cleaning surfaces are highly desirable in various industrial fields and in aspects of daily life. When rendered superhydrophobic (for example, ultra-water-repellent to the extent of having water contact angles greater than about 150°), surfaces exhibit a self-cleaning effect and an ability to maintain surface properties that are often detrimentally affected by water.

Control of the wettability of solid surfaces has conventionally been addressed by chemical modification of the surface, such as by the introduction of water-repellent functionalities (for example, fluoroalkyl groups). In order to achieve superhydrophobicity and its accompanying self-cleaning characteristics, however, both a low surface energy and a degree of surface micro-roughness or micro-texture are necessary.

Such combinations can be found in nature. Lotus leaves, for example, are self-cleaning due to an inherently low surface energy coupled with a microstructured surface comprising pyramidal elevations spaced a few micrometers apart.

In attempting to mimic such natural characteristics, there have been various different approaches to the production of self-cleaning surfaces. Superhydrophobic surfaces have been prepared, for example, by plasma processes, by vapor deposition, and by photolithography. Such methods have often not been suitable for industrial manufacturing, however, due to the need for multiple process steps and/or lengthy processing times. In addition, some of the surface textures resulting from these and other methods can be fragile and easily damaged.

Other approaches have employed coating compositions (for example, particle-containing binders), but coatings comprising hydrocarbon binders have tended to be somewhat lacking in chemical resistance and/or photoresistance. Fluoropolymer-based coatings have generally exhibited greater chemical stability and/or photostability but have often been difficult to bond to hydrocarbon substrates and therefore sometimes lacking in durability. Still other approaches have lacked heat resistance, have required high temperature treatment (and substrates that can withstand such treatment), and/or have lacked a desired degree of transparency (for example, due to particle-caused scattering).

### SUMMARY

Thus, we recognize that there is a need for industrially useful processes for imparting durable superhydrophobicity to substrates (for example, glass, metals, and organic polymers). Preferably, the processes will provide coatings that are not only durably superhydrophobic but also transparent.

Briefly, in one aspect, this invention provides such a process, which comprises (a) applying a coating consisting essentially of at least one hydrophobic material (that is, a material having a water contact angle of at least 90°) to at least a portion of at least one surface of a substrate to form a water repellent layer; (b) disposing a plurality of particles on the water repellent layer, the particles being selected from porous particles, particle aggregates, and mixtures thereof; (c) at least partially embedding the particles in the water repellent layer; (d) at least partially hardening the water repellent layer; and (e) removing the at least partially embedded particles to form a microstructured coating; wherein the microstructured coating comprises a plurality of cavities that taper from the exposed surface of the coating toward the substrate. Preferably, the microstructured coating is transparent.

It has been discovered that by properly controlling the shapes of irregularities (in the form of cavities) formed on a water repellent coating, the coating can exhibit not only water repellency (or hydrophobicity) but also a water-shedding or self-cleaning property that can be retained even after immersion of the coating in water. By forming cavities in a water repellent material and appropriately controlling the shapes of the cavities (such that they taper from the surface of the material toward its interior), it can be possible to achieve a relatively high water-shedding ability, even for fine water droplets such as mist, and to retain this property over prolonged periods. Surprisingly, such characteristics can be achieved even without the use of fluorochemical materials.

Water repellency, as referenced herein, means “static” water repellency (which can be determined by measuring the contact angle of a coating with water), while the above-mentioned water-shedding property is “dynamic” water repellency (which can be measured by determining the angle at which a water droplet that is dropped on a horizontal coated surface begins to roll when the surface is tilted (“rolling angle”)). Depending on the shapes of their irregularities, some prior art coatings or films (even some that exhibit relatively high contact angles with water) do not exhibit a water-shedding property for fine water droplets such as mist. Others initially exhibit a water-shedding property but, after prolonged immersion in water, gradually undergo a loss of their water-shedding property.

Unlike such prior art coatings, the coatings provided by the process of the invention can be durably superhydrophobic (that is, durably water repellent and durably water-shedding or self-cleaning) and, thus, can be used to impart superhydrophobic characteristics that are stable and long-lasting to various substrates. From a process standpoint, the coatings can generally be relatively easily formed on substrate surfaces and can be not only stable and durable but preferably also transparent (since, unlike at least some prior art coatings, particles do not remain in or on the coating). Thus, at least some embodiments of the process of the invention can meet the need in the art for industrially useful processes for preparing coatings that are durably superhydrophobic and preferably transparent.

In other aspects, this invention also provides a coating prepared by the process of the invention; and a coated sheet comprising a base film and the coating on at least a portion of at least one surface of the base film.

### BRIEF DESCRIPTION OF THE DRAWING

These and other features, aspects, and advantages of the present invention will become better understood with regard to the following description, appended claims, and accompanying drawing, wherein:

FIG. 1 shows, in sectional view, a microstructured coating produced by an embodiment of the process of the invention.

This figure, which is idealized, is not drawn to scale and is intended to be merely illustrative and nonlimiting.

### DETAILED DESCRIPTION

Definitions

As used in this patent application:

“contact angle” means contact angle with water (the value obtained by measurement with distilled water using a contact angle meter, for example, a FACE Contact Angle Meter Model CA-A available from Kyowa Interface Science Co., Ltd.), unless otherwise specified;

“hydrophobic material” means a material having a contact angle of at least 90°;

“transparent” means exhibiting haze of less than or equal to 15 percent (as measured by a haze meter, for example, Haze Meter SZ-Σ80 manufactured by Nippon Denshoku Industries Co., Ltd., having a measurement aperture diameter of 30 millimeters);

and

“rolling angle” means the angle at which a water droplet of at least 0.02 mL that is deposited on a horizontal coated surface begins to roll when the surface is tilted.

### DESCRIPTION OF PREFERRED EMBODIMENTS

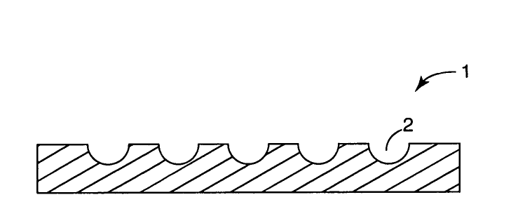

Referring to FIG. 1, an embodiment of the process of the invention provides a microstructured coating 1 comprising a plurality of cavities 2 that taper from the exposed surface of the coating toward its interior. The coating 1 consists or consists essentially of at least one hydrophobic material (that is, a material that exhibits water repellency with a contact angle of 90° or greater; preferably, a contact angle of 100° to 150°; more preferably, a contact angle of 110° to 150°; most preferably, a contact angle of 120° to 150°) that is capable of forming cavities or recesses. (The coating can “consist essentially” of such material(s), in that one or more materials having contact angles less than 90° can be present, provided that the contact angle of the overall mixture or blend of materials is 90° or greater. If the contact angle of of the mixture or blend is less than 90°, it can be difficult or impossible to achieve superhydrophobicity solely by control of the shapes of the cavities in the coating.) Although a larger contact angle is generally preferred, it will usually be no greater than 150°.

The hydrophobic material preferably contains essentially no fluorine. Examples of suitable hydrophobic materials include silicone-based adhesives and silicone-based resins, such as addition reaction-type silicones, polyurethanes, polyureas, polyepoxides, and the like, and mixtures thereof.

The cavities 2 of the coating 1 preferably occupy from 10 to 85 percent of the surface of the coating, and the typical cavity depth is preferably from 0.01 to 100 micrometers. The thickness of the coating is not particularly limited and can be varied so as to enable the formation of cavities having sufficient depth and appropriate shape to achieve the properties desired for a particular application.

In the present invention, the water-shedding or self-cleaning property of a coating can be enhanced by providing a microstructure on the coating surface and controlling the shape of the recessed portions of the microstructure. The recessed portions or cavities can be shaped to taper from the surface of the coating toward its interior. This means that the cavities expand or widen from their bottoms to their openings, and water that lodges in the cavities can readily roll off when the coating is inclined. If the cavities were to be shaped such that the bottom of a cavity is wider than its opening, water (particularly fine mist) that contacts the coating can become at least somewhat trapped in the cavities and thus can roll off less easily when the coating is inclined.

The coating provided by the process of the present invention exhibits a water contact angle that can be greater than the water contact angles of its components (preferably, the coating exhibits a water contact angle of 140° or more; more preferably, 150° or more). The water-shedding property of the coating can, as described above, be assessed by measuring its rolling angle. Coatings prepared by the process of the invention can exhibit rolling angles (using 0.02 mL water droplets) preferably as low as 25° or less (more preferably, 10° or less; most preferably, 5° or less) and thus can have relatively good water-shedding or self-cleaning characteristics. Not necessarily all of the cavities of the coating taper from its surface toward its interior, but, preferably, a sufficient number taper in that manner for the coating to exhibit the water-shedding properties that are desired for a particular application.

Preferably, the coatings further exhibit relatively high transparency, which can be assessed by measuring their haze using a haze meter. The coatings preferably exhibit a haze of 15 percent or less, more preferably 10 percent or less (for example, as measured by Haze Meter SZ-Σ80 manufactured by Nippon Denshoku Industries Co., Ltd., Tokyo, Japan, having a measurement aperture diameter of 30 mm).

The process of the invention can be carried out, for example, as follows. At least one of the above-described coating materials can be coated on a substrate (using essentially any known coating method, such as, for example, knife coating, bar coating, dipping, and the like, and combinations thereof) to form a water repellent layer, and a plurality of particles can be disposed on the water repellent layer. The particles can be at least partially embedded in the water repellent layer, and then the water repellent layer can be hardened (for example, by at least partially curing the coating materials by exposure to heat or to radiation). Finally, the particles can be removed from the water repellent layer (for example, by mechanical removal using an applied stream of fluid such as water or air).

The substrate can comprise essentially any commonly used substrate material (for example, polymer film (such as, for example, polyester, polyvinyl chloride, polyurethane, polypropylene, and the like), paper, metal, wood, concrete, ceramic, and the like, and combinations thereof). The above-described hydrophobic materials can also be used.

Particles that are suitable for use in carrying out the process of the invention include porous particles and particle aggregates (and mixtures thereof). The particles can comprise essentially any material (for example, useful non-hydrophobic materials include acrylic- and methacrylic-based resins, metals such as aluminum and iron, ceramics such as silica and alumina, and the like, and mixtures thereof). The particles can also comprise one or more hydrophobic materials (for example, polyethylene, polypropylene, polystyrene, and the like, and mixtures thereof). Preferably, the particles contain essentially no fluorine.

As mentioned above, useful particles are porous or aggregated. Cavities formed by using non-porous particles generally exhibit less good water-shedding ability than those formed by using their more porous counterparts. Porous particles include those having small openings or holes in the particle surface, whereby the apparent contact angle of the particle is higher than the actual contact angle of the material composing it. For example, the particles can have a specific surface area of 10-200 m²/g and a pore size of 150-200 Å. Aggregates of particles are particles that are grouped together and that thereby exhibit porosity that is similar to that of porous particles.

The particles can be substantially spherical (including, for example, spheres and spheroids). Useful particles also include, however, conical and pyramidal particles, as well as truncated conical and truncated pyramidal particles, and the like, and mixtures thereof. The particles can be microparticles. Useful particle sizes include average diameters of 0.01-500 micrometers (preferably, 0.05-300 micrometers; more preferably, 0.1-100 micrometers; where “diameter” refers not only to the diameter of substantially spherical particles but also to the longest dimension of non-spherical particles). The particles need not be separated from each other but rather can be at least partially connected and arrayed like a lattice, if desired.

When the particles are disposed on the water-repellent layer, the layer is in an unhardened state, and, thus, the particles can be at least partially embedded in it (if desired, by applying pressure). After the particles are at least partially embedded, the water-repellent layer can be hardened, and the particles can be removed (for example, by blowing them off using a water spray gun or an air gun, or by applying and then removing a pressure-sensitive adhesive tape) to form a microstructured coating. The particles can be used and removed in amounts such that the resulting cavities occupy from 10 to 85 percent of the coating surface, as described above.

The cavities can be shaped to taper from the surface of the coating toward its interior. When substantially spherical particles are used, less than or equal to 60 percent (preferably, less than or equal to 50 percent) of their average particle size can be embedded or buried in the unhardened water-repellent layer. If more than 60 percent is buried, the cavities formed by removal of the particles can have a shape that widens from the surface of the coating toward its interior, thereby decreasing the water-shedding ability of the coating.

When the thickness of the water-repellent layer is set to 60 percent or less of the average particle size, however, even if the substantially spherical particles are pressed so as to reach the underlying substrate, at most 60 percent of their average particle size can be embedded in the water-repellent layer. Thus, even when using substantially spherical particles, cavities that taper from the coating surface toward its interior can be easily formed. When particles having a tapered shape (for example, conical) are used, cavities having the preferred shape characteristics can be formed by embedding the tapered ends of the particles in the water-repellent layer.

Alternatively, the process of the invention can be carried out by mixing the above-described water-repellent material and the particles to form a mixture, coating the mixture on a substrate, hardening the water-repellent material, and then removing the particles that are exposed on the surface of the material, so as to form a microstructured coating. When substantially spherical particles are used, particles having 40 percent or more of the average particle size exposed can be removed. Preferably, the coating thickness is 60 percent or less of the average particle size, or the volume percentage of particles in the mixture is 30 to 70 percent (more preferably, 40 to 60 percent).

A superhydrophobic sheet can be obtained by providing the above-described microstructured coating on at least a portion of at least one surface of a substrate. The sheet can exhibit a water-shedding property, which can be measured by determining the angle at which a water droplet that is deposited on the coated side of the sheet begins to roll when the sheet is tilted (the rolling angle), as explained above. A sheet according to the invention can exhibit a rolling angle (for a dropped 0.02 mL water droplet) of preferably 25° or less (more preferably of 10° or less; most preferably of 5° or less). Preferred coatings can also exhibit a rolling angle, for a deposited 0.02 mL water droplet, of 25° or less after immersion in water for a period of one hour.

### EXAMPLES

Objects and advantages of this invention are further illustrated by the following examples, but the particular materials and amounts thereof recited in these examples, as well as other conditions and details, should not be construed to unduly limit this invention.

### Example 1

### Preparation of a Silicone-Based, Superhydrophobic Coating

A two-part silicone adhesive (0.3 g; a mixture of 0.15 g of each part of a silicone adhesive available under the trade designation “X-34-1662(A/B)” from Shin-Etsu Chemical Co., Ltd., Tokyo, Japan) was dissolved in 5 g of a mixture of one part by weight methyl ethyl ketone (MEK) and two parts by weight of a hydrofluoroether (available under the trade designation “3M NOVEC Engineered Fluid HFE-7200” from 3M Company, St. Paul, Minn.). The resulting solution was coated on a sheet of poly(ethylene terephthalate) (PET) film. The thickness of the resulting silicone adhesive solution coating was empirically determined to provide a dry adhesive coating thickness of approximately 1 micrometer. Porous poly(styrene) particles having a mean particle size of approximately 8 micrometers (obtained under the trade designation “SBP-8” from Sekisui Plastics Co., Ltd., Tokyo, Japan) were distributed over the entire surface of the coated silicone adhesive and were allowed to become embedded in the adhesive. The coated sheet was left to stand at room temperature for approximately 24 hours. A relatively strong stream of water was then directed at the coated sheet to remove the porous poly(styrene) particles to form a microstructured coating.

The resulting coated sheet was placed on a stage that could be tilted or inclined (with respect to the horizontal) through a range of angles. A drop of water having a volume of approximately 0.02 mL was placed on the surface of the coating, and then the stage was slowly tilted. The angle of the stage (with respect to the horizontal) at which the water drop began to roll down the surface of the coating was determined to be less than 1°. The coating was then sprayed with water, and the water was observed to roll off of the coating. The haze and parallel transmittance of the coating were measured using a SZ-SIGMA 80 haze meter (obtained from Nippon Denshoku Industries Co., Ltd., Tokyo, Japan) using a 30 millimeter diameter aperture. The haze value was determined to be 7.5 percent (%), and the parallel transmittance was determined to be 84%.

### Comparative Example 1

### Preparation of a Coating Comprising Particles

A coating was prepared in a manner similar to that described in Example 1, except that the thickness of the silicone adhesive solution coating was empirically determined to provide a dry adhesive coating thickness of approximately 6 micrometers. A relatively strong stream of water directed at the coated sheet did not remove the porous poly(styrene) particles. The haze and parallel transmittance of the coating were measured using essentially the method described in Example 1. The haze value was determined to be 90%, and the parallel transmittance was determined to be 10%.

### Example 2

### Preparation of a Silicone-Based, Superhydrophobic Coating

A coating was prepared in a manner similar to that described in Example 1, except that the particles were porous poly(methyl methacrylate) particles having a mean particle size of approximately 8 micrometers (obtained under the trade designation “MBP-8” from Sekisui Plastics Co., Ltd., Tokyo, Japan). The resulting coating was evaluated essentially as described in Example 1. The angle of the stage (with respect to the horizontal) at which the water drop began to roll down the surface of the coating was determined to be less than 1°. The coating was then sprayed with water, and the water was observed to roll off of the coating. The haze and of the coating was determined to be 6%, and the parallel transmittance was determined to be 85%.

### Example 3

### Preparation of a Silicone-Based, Superhydrophobic Coating

A mixture of 0.3 g of a curable silicone resin (available under the trade designation “KE-1310ST” from Shin-Etsu Chemical Co., Ltd., Tokyo, Japan) and 0.03 g of a curing catalyst (available under the trade designation “CAT-1310” from Shin-Etsu Chemical Co., Ltd.) was dissolved in 5 g of a mixture of one part by weight methyl ethyl ketone and two parts by weight of a hydrofluoroether (available under the trade designation “3M NOVEC Engineered Fluid HFE-7200” from 3M Company, St. Paul, Minn.). The resulting solution was coated on a sheet of poly(ethylene terephthalate) film at a thickness that was empirically determined to provide a dry adhesive coating thickness of approximately 1 micrometer. Porous poly(styrene) particles having a mean particle size of approximately 8 micrometers (obtained under the trade designation “SBP-8” from Sekisui Plastics Co., Ltd., Tokyo, Japan) were distributed over the entire surface of the coated silicone resin and were allowed to become embedded in the resin. The resulting coated sheet was heated in an oven at 100° C. for approximately 24 hours and was then allowed to cool to room temperature. A relatively strong stream of water was then directed at the coated sheet to remove the porous poly(styrene) particles to form a microstructured coating.

The resulting coated sheet was placed on a stage that could be tilted or inclined (with respect to the horizontal) through a range of angles. A drop of water having a volume of approximately 0.02 mL was placed on the surface of the coating, and then the stage was slowly tilted. The angle of the stage (with respect to the horizontal) at which the water drop began to roll down the surface of the coating was determined to be less than 1°. The coating was then sprayed with water, and the water was observed to roll off of the coating. The haze and parallel transmittance of the coating were measured using a SZ-SIGMA 80 haze meter (obtained from Nippon Denshoku Industries Co., Ltd., Tokyo, Japan) using a 30 millimeter diameter aperture. The haze value was determined to be 8%, and the parallel transmittance was determined to be 83%.

### Example 4

### Preparation of a Silicone-Based, Superhydrophobic Coating

A two-part silicone adhesive (0.3 g; a mixture of 0.15 g of each part of a silicone adhesive available under the trade designation “KE-2000(A/B)” from Shin-Etsu Chemical Co., Ltd., Tokyo, Japan) was dissolved in 5 g of a mixture of one part by weight methyl ethyl ketone and two parts by weight of a hydrofluoroether (available under the trade designation “3M NOVEC Engineered Fluid HFE-7200” from 3M Company, St. Paul, Minn.). The resulting solution was coated on a sheet of poly(ethylene terephthalate) film. The thickness of the resulting silicone adhesive solution coating was empirically determined to provide a dry adhesive coating thickness of approximately 1 micrometer. Porous poly(styrene) particles having a mean particle size of approximately 8 micrometers (obtained under the trade designation “SBP-8” from Sekisui Plastics Co., Ltd., Tokyo, Japan) were distributed over the entire surface of the coated silicone adhesive and were allowed to become embedded in the adhesive. The resulting coated sheet was left to stand at room temperature for approximately 24 hours. A relatively strong stream of water was then directed at the coated sheet to remove the porous poly(styrene) particles to form a microstructured coating.

The resulting coating was evaluated essentially as described in Example 1. The angle of the stage (with respect to the horizontal) at which the water drop began to roll down the surface of the coating was determined to be less than 1°. The coating was then sprayed with water, and the water was observed to roll off of the coating. The haze value was determined to be 7.5%, and the parallel transmittance was determined to be 84%.

### Example 5

### Preparation of a Silicone-Based, Superhydrophobic Coating

A coating was prepared in a manner similar to that described in Example 3, except that porous poly(styrene) particles having a mean particle size of approximately 20 micrometers (obtained under the trade designation “SBP-20” from Sekisui Plastics Co., Ltd., Tokyo, Japan) were distributed over the entire surface of the coated silicone resin and were allowed to become embedded in the resin. The coating was evaluated essentially as described in Example 3. The angle of the stage (with respect to the horizontal) at which the water drop began to roll down the surface of the coating was determined to be approximately 1°. The coating was then sprayed with water, and the water was observed to roll off of the coating. The haze value was determined to be 5.6%, and the parallel transmittance was determined to be 85%.

### Example 6

### Preparation of a Silicone-Based, Superhydrophobic Coating

A coating was prepared in a manner similar to that described in Example 3, except that porous poly(styrene) particles having a mean particle size of approximately 5 micrometers (obtained under the trade designation “SBP-5” from Sekisui Plastics Co., Ltd., Tokyo, Japan) were distributed over the entire surface of the coated silicone resin and were allowed to become embedded in the resin. The resulting coating was evaluated essentially as described in Example 3. The angle of the stage (with respect to the horizontal) at which the water drop began to roll down the surface of the coating was determined to be approximately 1°. The coating was then sprayed with water, and the water was observed to roll off of the coating. The haze value was determined to be 5.1%, and the parallel transmittance was determined to be 86%.

### Example 7

### Preparation of a Silicone-Based, Superhydrophobic Coating

A coating was prepared in a manner similar to that described in Example 3, except that porous spherical silica particles having a mean particle size of approximately 7 micrometers (obtained under the trade designation “C-1507” from Fuji Silysia Chemical Ltd., Kasugai, Japan) were distributed over the entire surface of the coated silicone resin and were allowed to become embedded in the resin. The resulting coating was evaluated essentially as described in Example 3. The angle of the stage (with respect to the horizontal) at which the water drop began to roll down the surface of the coating was determined to be approximately 2°. The coating was then sprayed with water, and the water was observed to roll off of the coating. The haze value was determined to be 3.8%, and the parallel transmittance was determined to be 87%.

### Example 8

### Preparation of a Silicone-Based, Superhydrophobic Coating

A coating was prepared in a manner similar to that described in Example 3, except that porous silica particles having a mean particle size of approximately 2.5 micrometers (obtained under the trade designation “SYLYSIA 436” from Fuji Silysia Chemical Ltd., Kasugai, Japan) were distributed over the entire surface of the coated silicone resin and were allowed to become embedded in the resin. The resulting coating was evaluated essentially as described in Example 3. The angle of the stage (with respect to the horizontal) at which the water drop began to roll down the surface of the coating was determined to be approximately 2°. The coating was then sprayed with water, and the water was observed to roll off of the coating. The haze value was determined to be 6.5%, and the parallel transmittance was determined to be 84%.

### Example 9

### Preparation of a Silicone-Based, Superhydrophobic Coating

A mixture of 100 parts by weight of a curable silicone resin (available under the trade designation “KE-1310ST” from Shin-Etsu Chemical Co., Ltd., Tokyo, Japan) and 10 parts by weight of a curing catalyst (available under the trade designation “CAT-1310” from Shin-Etsu Chemical Co., Ltd.) was dissolved in a mixture of one part by weight methyl ethyl ketone and two parts by weight of a hydrofluoroether (available under the trade designation “3M NOVEC Engineered Fluid HFE-7200” from 3M Company, St. Paul, Minn.) to provide a solution that had a solids concentration of 20 weight percent. Porous poly(styrene) particles having a mean particle size of approximately 8 micrometers (0.1 g; obtained under the trade designation “SBP-8” from Sekisui Plastics Co., Ltd., Tokyo, Japan) were combined with 0.5 g of the solution to provide a coating solution. This coating solution was coated on a sheet of poly(ethylene terephthalate) film using a No. 4 wound wire coating rod. The resulting coated sheet was heated in an oven at 100° C. for approximately 24 hours and was then allowed to cool to room temperature. A relatively strong stream of water was then directed at the coated sheet to remove the porous poly(styrene) particles to form a microstructured coating.

The resulting coating was evaluated essentially as described in Example 3. The angle of the stage (with respect to the horizontal) at which the water drop began to roll down the surface of the coating was determined to be approximately 3°. The coating was then sprayed with water, and the water was observed to roll off of the coating. The haze value was determined to be less than 15%, and the parallel transmittance was determined to be greater than 75%.

### Example 10

### Preparation of a Silicone-Based, Superhydrophobic Coating

A mixture of 50 parts by weight of each part of a two-part silicone adhesive (available under the trade designation “X-34-1690A/B” from Shin-Etsu Chemical Co., Ltd., Tokyo, Japan) was dissolved in a mixture of one part by weight methyl ethyl ketone and two parts by weight of a hydrofluoroether (available under the trade designation “3M NOVEC Engineered Fluid HFE-7200” from 3M Company, St. Paul, Minn.) to provide a solution that had a solids concentration of 20 weight percent. Porous poly(styrene) particles having a mean particle size of approximately 8 micrometers (0.1 g; obtained under the trade designation “SBP-8” from Sekisui Plastics Co., Ltd., Tokyo, Japan) were combined with 0.5 g of the solution to provide a coating solution. This coating solution was coated on a sheet of poly(ethylene terephthalate) film using a No. 8 wound wire coating rod. The coated sheet was heated in an oven at 100° C. for approximately 24 hours and was then allowed to cool to room temperature. A relatively strong stream of water was then directed at the coated sheet to remove the porous poly(styrene) particles to form a microstructured coating.

The resulting coating was evaluated essentially as described in Example 3. The angle of the stage (with respect to the horizontal) at which the water drop began to roll down the surface of the coating was determined to be approximately 4°. The coating was then sprayed with water, and the water was observed to roll off of the coating. The haze value was determined to be less than 15%, and the parallel transmittance was determined to be greater than 75%.

### Example 11

### Preparation of a Silicone-Based, Superhydrophobic Coating

A mixture of 50 parts by weight of each part of a two-part silicone adhesive (available under the trade designation “KE-2000A/B” from Ship-Etsu Chemical Co., Ltd., Tokyo, Japan) was dissolved in a mixture of one part by weight methyl ethyl ketone and two parts by weight of a hydrofluoroether (available under the trade designation “3M NOVEC Engineered Fluid HFE-7200” from 3M Company, St. Paul, Minn.) to provide a solution that had a solids concentration of 20 weight percent. Porous poly(styrene) particles having a mean particle size of approximately 8 micrometers (0.1 g; obtained under the trade designation “SBP-8” from Sekisui Plastics Co., Ltd., Tokyo, Japan) were combined with 0.5 g of the solution to provide a coating solution. This coating solution was coated on a sheet of poly(ethylene terephthalate) film using a No. 20 wound wire coating rod. The resulting coated sheet was heated in an oven at 100° C. for approximately 24 hours and was then allowed to cool to room temperature. A relatively strong stream of water was then directed at the coated sheet to remove the porous poly(styrene) particles to form a microstructured coating.

The resulting coating was evaluated essentially as described in Example 3. The angle of the stage (with respect to the horizontal) at which the water drop began to roll down the surface of the coating was determined to be approximately 4°. The coating was then sprayed with water, and the water was observed to roll off of the coating. The haze value was determined to be less than 15%, and the parallel transmittance was determined to be greater than 75%.

### Comparative Example 2

### Preparation of a Coating Comprising Particles

A mixture of 0.3 g of a curable silicone resin (available under the trade designation “KE-1310ST” from Shin-Etsu Chemical Co., Ltd., Tokyo, Japan) and 0.03 g of a curing catalyst (available under the trade designation “CAT-1310” from Shin-Etsu Chemical Co., Ltd.) was dissolved in 5 g of a mixture of one part by weight methyl ethyl ketone and two parts by weight of a hydrofluoroether (available under the trade designation “3M NOVEC Engineered Fluid HFE-7200” from 3M Company, St. Paul, Minn.). Porous poly(styrene) particles having a mean particle size of approximately 8 micrometers (0.1 g; obtained under the trade designation “SBP-8” from Sekisui Plastics Co., Ltd., Tokyo, Japan) were combined with 0.1 g of the resulting solution to provide a coating mixture that was difficult to mix. This coating mixture was coated on a sheet of poly(ethylene terephthalate) film using a No. 4 wound wire coating rod. The resulting coated sheet was heated in an oven at 100° C. for approximately 24 hours and was then allowed to cool to room temperature. Cracks were observed to have formed in the surface of the coating.

### Comparative Example 3

### Preparation of a Coating Comprising Particles

A mixture of 0.3 g of a curable silicone resin (available under the trade designation “KE-1310ST” from Shin-Etsu Chemical Co., Ltd., Tokyo, Japan) and 0.03 g of a curing catalyst (available under the trade designation “CAT-1310” from Shin-Etsu Chemical Co., Ltd.) was dissolved in 5 g of a mixture of one part by weight methyl ethyl ketone and two parts by weight of a hydrofluoroether (available under the trade designation “3M NOVEC Engineered Fluid HFE-7200” from 3M Company, St. Paul, Minn.). Porous poly(styrene) particles having a mean particle size of approximately 8 micrometers (0.1 g; obtained under the trade designation “SBP-8” from Sekisui Plastics Co., Ltd., Tokyo, Japan) were combined with 1.0 g of the resulting solution to provide a coating mixture. This coating mixture was coated on a sheet of poly(ethylene terephthalate) film using a No. 8 wound wire coating rod. The resulting coated sheet was heated in an oven at 100° C. for approximately 24 hours and was then allowed to cool to room temperature. A relatively strong stream of water was then directed at the coated sheet in an attempt to remove the porous poly(styrene) particles, but the particles remained in the coating.

### Comparative Example 4

### Preparation of a Coating Comprising Particles

A mixture of 0.3 g of a curable silicone resin (available under the trade designation “KE-1310ST” from Shin-Etsu Chemical Co., Ltd., Tokyo, Japan) and 0.03 g of a curing catalyst (available under the trade designation “CAT-1310” from Shin-Etsu Chemical Co., Ltd.) was dissolved in 5 g of a mixture of one part by weight methyl ethyl ketone and two parts by weight of a hydrofluoroether (available under the trade designation “3M NOVEC Engineered Fluid HFE-7200” from 3M Company, St. Paul, Minn.). Porous poly(styrene) particles having a mean particle size of approximately 8 micrometers (0.1 g; obtained under the trade designation “SBP-8” from Sekisui Plastics Co., Ltd., Tokyo, Japan) were combined with 1.5 g of the resulting solution to provide a coating mixture. This coating mixture was coated on a sheet of poly(ethylene terephthalate) film using a No. 20 wound wire coating rod. The resulting coated sheet was heated in an oven at 100° C. for approximately 24 hours and was then allowed to cool to room temperature. A relatively strong stream of water was then directed at the coated sheet in an attempt to remove the porous poly(styrene) particles, but the particles remained in the coating.

The referenced descriptions contained in the patents, patent documents, and publications cited herein are incorporated by reference in their entirety as if each were individually incorporated. Various unforeseeable modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only, with the scope of the invention intended to be limited only by the claims set forth herein as follows:

We claim:

1. A process comprising
(a) applying a coating consisting essentially of at least one hydrophobic material to at least a portion of at least one surface of a substrate to form a water repellent layer;
(b) disposing a plurality of particles on said water repellent layer, said particles being selected from porous particles, particle aggregates, and mixtures thereof;
(c) at least partially embedding said particles in said water repellent layer;
(d) at least partially hardening said water repellent layer; and
(e) removing the at least partially embedded particles to form a microstructured coating;
wherein said microstructured coating comprises a plurality of cavities that taper from the exposed surface of said coating toward said substrate.

2. The process of claim 1, wherein said microstructured coating is transparent.

3. The process of claim 1, wherein said hydrophobic material contains no fluorine.

4. The process of claim 1, wherein said hydrophobic material is selected from silicone-based adhesives, silicone-based resins, polyurethanes, polyureas, polyepoxides, and mixtures thereof.

5. The process of claim 1, wherein said particles contain no fluorine.

6. The process of claim 1, wherein said particles comprise at least one material selected from acrylic- and methacrylic-based resins, metals, ceramics, polyethylene, polypropylene, polystyrene, and mixtures thereof.

7. The process of claim 1, wherein said particles are selected from substantially spherical particles, conical particles, pyramidal particles, truncated conical particles, truncated pyramidal particles, and mixtures thereof.

8. The process of claim 7, wherein said particles are substantially spherical particles.

9. The process of claim 8, wherein said particles have less than or equal to 60 percent of their average particle size embedded in said water-repellent layer.

10. The process of claim 1, wherein said particles are microparticles.

11. The process of claim 1, wherein said microstructured coating exhibits a rolling angle, for a deposited 0.02 mL water droplet, of 25° or less.

12. The process of claim 1, wherein said microstructured coating exhibits a rolling angle, for a deposited 0.02 mL water droplet, of 25° or less after immersion in water for a period of one hour.

13. The process of claim 1, wherein said applying, disposing, and embedding steps are effected by forming a mixture comprising said hydrophobic material and said particles and applying said mixture to said substrate.

14. The process of claim 1, wherein said embedding is effected by application of pressure.

15. The process of claim 1, wherein said hardening comprises at least partially curing said water repellent layer by application of heat or radiation.

16. The process of claim 1, wherein said removing is effected by application of a stream of fluid.

17. A process comprising
(a) applying a coating consisting essentially of at least one hydrophobic material selected from silicone-based adhesives, silicone-based resins, and mixtures thereof to at least a portion of at least one surface of a substrate to form a water repellent layer;
(b) disposing a plurality of porous polystyrene microparticles on said water repellent layer;
(c) at least partially embedding said particles in said water repellent layer by application of pressure;
(d) at least partially curing said water repellent layer by application of heat; and
(e) removing the at least partially embedded particles by application of a stream of water to form a microstructured coating;
wherein said microstructured coating comprises a plurality of cavities that taper from the exposed surface of said coating toward said substrate such that said coating exhibits a rolling angle, for a deposited 0.02 mL water droplet, of 25° or less.

18. A coating produced by the process of claim 1.

19. A coating produced by the process of claim 17.

20. A coated sheet comprising a base film and the coating of claim 18 on at least a portion of at least one surface of said base film.

21. A coated sheet comprising a base film and the coating of claim 19 on at least a portion of at least one surface of said base film.
